(19) United States
(12) Patent Application Publication
(10) Pub. No.: US 2019/0340230 A1
(43) Pub. Date: Nov. 7, 2019

(54) SYSTEM AND METHOD FOR GENERATING WEBSITES FROM PREDEFINED TEMPLATES

(71) Applicant: Web.com Group, Inc., Jacksonville, FL (US)

(72) Inventors: Nicholas James Gall, Jacksonville, FL (US); Jared Bridegan, Ponte Vedra, FL (US); David Dalcu, Jacksonville, FL (US); Edward Allen Hensch, Jacksonville, FL (US); Román Lisin, Caba (AR)

(21) Appl. No.: 15/972,848

(22) Filed: May 7, 2018

(51) Int. Cl. G06F 17/24; G06F 17/30; G06F 8/30; G06F 8/71; G06F 17/22; G06F 17/27

(52) U.S. Cl. CPC G06F 17/248; G06F 17/30896; G06F 8/30; G06F 3/0482; G06F 17/2288; G06F 17/272; G06F 17/2247; G06F 8/71

(57) ABSTRACT

Disclosed are various embodiments for generating websites based on user inputs corresponding to a desired business category and desired structural attributes. A website template is selected based on the desired business category. HTML code for the website is generated based on pre-generated HTML code corresponding to the selected template to match the desired structural attributes.

### BACKGROUND

Websites contain a number of individual pages that usually contain Hypertext Markup Language (HTML) code and other code. When a visitor wishes to view a website, they direct their web browser to a Uniform Resource Locator (URL) corresponding to the website. The web browser receives the HTML code and renders the website. Consumers can create websites using tools that allow the consumer to visually create and arrange various elements in webpages without writing the HTML code. Consumers can also create websites using various web-based creation tools that generate websites based on the user's inputs and selections.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a schematic block diagram of a networked environment according to various embodiments of the present disclosure.

FIG. 2 is a schematic block diagram depicting various data stores within the networked environment of FIG. 1 according to various embodiments of the present disclosure.

FIG. 3-4 are pictorial diagrams of example user interfaces rendered by a client device in the networked environment of FIG. 1 according to various embodiments of the present disclosure.

FIG. 5 is a flowchart illustrating one example of functionality implemented as portions of builder service executed in a computing environment in the networked environment of FIG. 1 according to various embodiments of the present disclosure.

FIG. 6 is a schematic block diagram that provides one example illustration of a computing environment employed in the networked environment of FIG. 1 according to various embodiments of the present disclosure.

### DETAILED DESCRIPTION

Consumers can use tools to create websites. However, these tools require the consumer to provide relevant graphics and themes for the website. Further, the consumer may need to edit or modify pages or content of the website which requires the consumer to regenerate the HTML code. Additionally, if the consumer makes changes to the graphics or theme of the website, they may need to propagate these changes throughout each and every page. Alternatively, consumers can also use web-based tools to create their website. These web-based creation tools store information about the website, such as images to use, page content, links, code, etc. in a proprietary database and provide the pages by querying the database for each request from a web browser to display the website. These web-based creation tools offer flexibility and ease of use to the consumer in creating a website. However, these tools have to query the webpages from the proprietary database in response to requests. As the number of queries for the website increases, the number of queries to the database increases as well. This requires considerable computing power to serve a high volume of page requests.

Various embodiments of the present disclosure relate to systems and methods for generating one or more websites. For example, the systems and methods of the present disclosure create one or more websites, including various individual pages of the website, based at least in part on certain information about the website provided by a user. The user may choose a business category for the website to be created. The user may also choose various types of content to be included in the website. A website is created using the systems and methods described herein, for the user to view and edit, via a browser on their device. The website is created using a template that corresponds to the user provided business category. The user can personalize the created website by adding content to the website via their browser. Once the user has customized the website, the user may preview the website to see how it would appear to a visitor. The user may choose to publish this website, i.e., to make it accessible via a preselected domain name.

In order to publish the website, various elements of the created website, such as images, text, and themes corresponding to the template are extracted from the database and used to generate HTML code. This generated HTML code is then used to create a published version of the website. The published website also includes any user included elements, such as images, audiovisual files, and content. These elements, when appropriate, are also exported, as separate files, so that they can be saved alongside the generated HTML code, or similar files. The published website, i.e., the generated HTML files and other files, are then uploaded to a publically accessible web server that corresponds to the selected domain name, if provided. This approach in creating the website allows the flexibility to design and customize the website in a user friendly visual interface. Further, the published website that uses the generated HTML, or similar files, provides an advantage over other web-based tools that use databases to store the website data in that the methods and systems in accordance with the various embodiments of the present disclosure can serve a large number of page requests without needing additional hardware or processing, as compared to conventional websites that store the content in databases and need additional computing resources to serve a large number of page requests.

According to various embodiments of the present disclosure, a web-based website generation system may be used to visually customize and edit various elements of a generated website. A data store is used to store the elements of the website, such as, for example, content, images, text, theme, video, links, etc. The web-based website generation system uses the information stored in the data store to create a website that can be modified by the user creating the website. For example, the user may add content or edit the website. After the website content is finalized, the web-based website generation system can preview the website by causing the preview to be rendered on a display of a client device. The rendered preview shows the exact look and feel of the website prior to publication, including its various webpages. The website generation system can then publish the website to a web server which is publically accessible, such as, for example, over the World Wide Web.

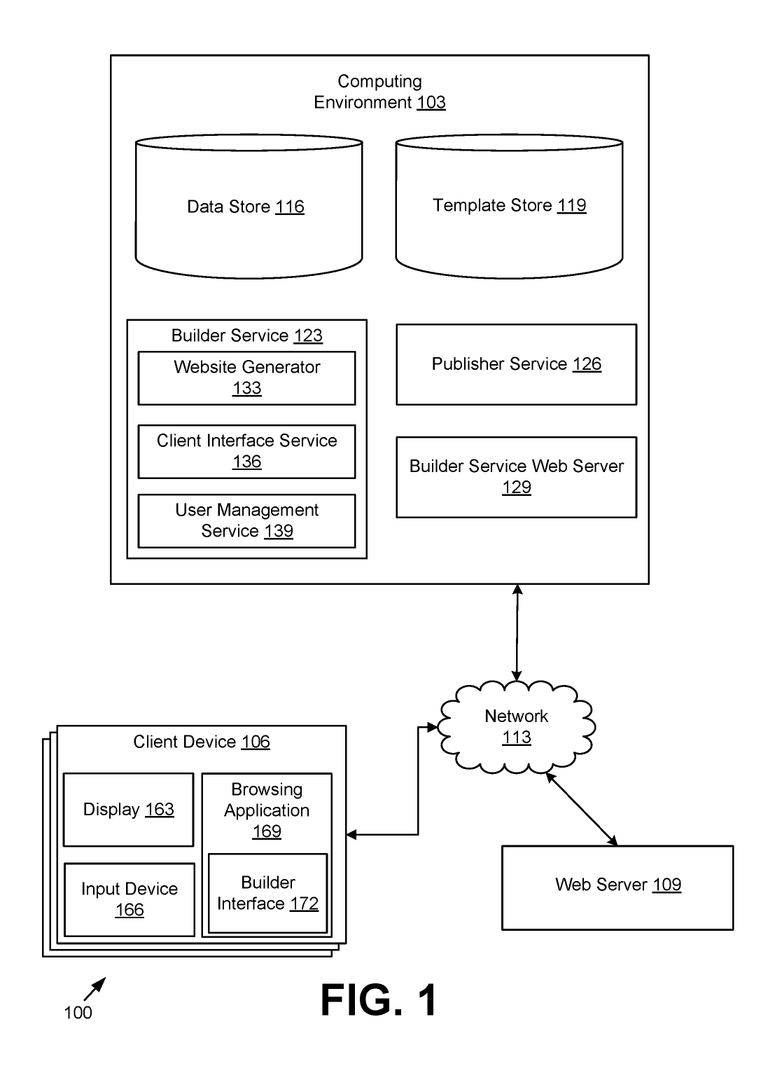

Turning now to the drawings, exemplary embodiments are described in detail. With reference to FIG. 1, shown is a networked environment 100 according to various embodiments. The networked environment 100 includes a computing environment 103, a client device 106, and a web server 109, which are in data communication with each other via a network 113. The network 113 includes, for example, the Internet, intranets, extranets, wide area networks (WANs), local area networks (LANs), wired networks, wireless networks, cable networks, satellite networks, or other suitable networks, etc., or any combination of two or more such networks.

The computing environment 103 may comprise, for example, a server computer or any other system providing computing capability. Alternatively, the computing environment 103 may employ a plurality of computing devices that may be arranged, for example, in one or more server banks or computer banks or other arrangements. Such computing devices may be located in a single installation or may be distributed among many different geographical locations. For example, the computing environment 103 may include a plurality of computing devices that together may comprise a hosted computing resource, a grid computing resource, and/or any other distributed computing arrangement. In some cases, the computing environment 103 may correspond to an elastic computing resource where the allotted capacity of processing, network, storage, or other computing-related resources may vary over time.

Various applications and/or other functionality may be executed in the computing environment 103 according to various embodiments. Also, various data is stored in a data store 116 and a template store 119 that is accessible to the computing environment 103. Each of the data store 116 and the template store 119 may be representative of a plurality of data stores as can be appreciated. The data stored in the data store 116 and template store 119 for example, is associated with the operation of the various applications and/or functional entities described below.

The components executed on the computing environment 103, for example, include a builder service 123, a publisher service 126, a builder service web server 129, and other applications, services, processes, systems, engines, or functionality not discussed in detail herein. The builder service 123 includes a website generator 133, a client interface service 136, and a user management service 139. The website generator 133 is executed to generate a website for display on a client device. The client interface service 136 is executed to generate an interface on a client device web browser application that interfaces with the website generator 133. The user management service 139 is executed to authenticate a client device 106 for access to the client interface service 136 via the client device's web browser application. The publisher service 126 is executed to publish the website to the web server 109. The builder service web server 129 is executed to host the builder service 123 and make it accessible to client devices 106 over network 113.

The data stored in the data store 116 includes, for example, website attributes, business attribute, website structure, website content, website data, and potentially other data. The data stored in the template store 119 includes, for example, templates, template mapping, and potentially other data.

The client device 106 is representative of a plurality of client devices that may be coupled to the network 113. The client device 106 may comprise, for example, a processor-based system such as a computer system. Such a computer system may be embodied in the form of a desktop computer, a laptop computer, personal digital assistants, cellular telephones, smartphones, set-top boxes, music players, web pads, tablet computer systems, game consoles, electronic book readers, smartwatches, head mounted displays, voice interface devices, or other devices. The client device 106 may include a display 163. The display 163 may comprise, for example, one or more devices such as liquid crystal display (LCD) displays, gas plasma-based flat panel displays, organic light emitting diode (OLED) displays, electrophoretic ink (E ink) displays, LCD projectors, or other types of display devices, etc.

The client device 106 may be configured to execute various applications such as a browsing application 169 and/or other applications. The browsing application 169 may be executed in a client device 106, for example, to access network content served up by the computing environment 103 and/or other servers, thereby rendering a builder interface 172 on the display 163. To this end, the browsing application 169 may comprise, for example, a browser, a dedicated application, etc., and the builder interface 172 may comprise a network page, an application screen, etc. The client device 106 may be configured to execute applications beyond the browsing application 169 such as, for example, email applications, social networking applications, word processors, spreadsheets, and/or other applications.

The web server 109 may be configured to host websites created in accordance with various embodiments of the present disclosure. The web server 109 may be accessible to the browsing application 169 of the client device 106. In various embodiments, the web server 109 is executed by a computing environment, such as the computing environment 103. In various embodiments, the web server 109 and the builder service web server 129 may be a single web server executed by a single computing environment.

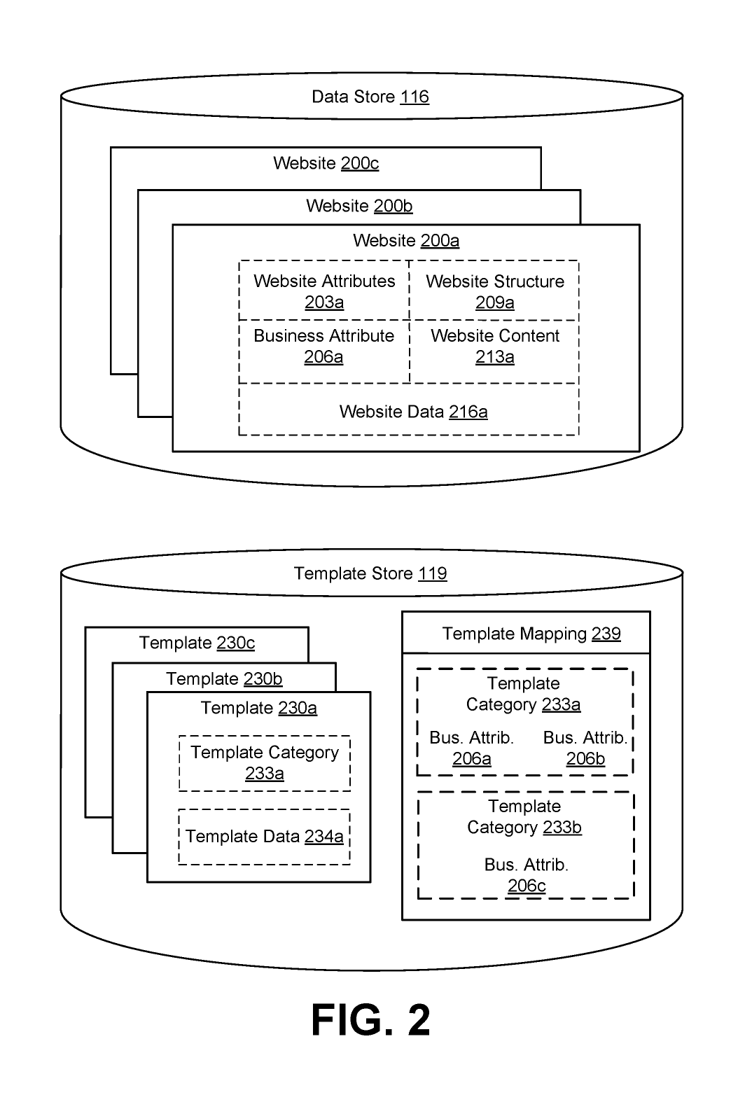

With reference to FIG. 2, shown are various data stores according to various embodiments of the present disclosure. Data store 116 is used to store data relating to a number of websites, such as, for example, website 200a, 200b, and 200c. For each of the websites that are created, the data store 116 stores website attributes 203, e.g. 203a, a business attribute 206, e.g., 206a, website structure 209, e.g., 209a, website content 213, e.g. 213a, and website data 216, e.g. 216a, and other data. Website attributes 203 can include a business name, a website address, such as a domain name to be associated with the website, and/or any other type of attributes as can be appreciated. Business attribute 206 can include a business type for the website. For example, a business type can include accountant, doctor, lawyer, handyman, home inspector, online e-commerce, online teaching, etc. Website structure 209 can contain information about the structure aspects of the website, such as number of pages to be included in the website, the relationship of the pages (e.g., how they are linked to each other), components, if any, to be included one or more of the pages. The components can provide certain functionality to the website, such as accepting payments, making appointments, displaying videos, providing e-commerce functionality, displaying a blog, etc. Website content 213 can include images, text, code, graphics, audio, video, and/or other content. For example, website content 213 includes any textual description in one or more webpages of the website 200. Website content 213 may also include links to images or videos that a user may wish to have displayed on their website or one any of individual pages. In various embodiments, the images or videos may also be stored in data store 116. In various embodiments, images or videos may be stored in a filesystem and linked to the data store 116.

Website data 216 may include other content that may be used by the website generator 133. For example, the website data 216 may contain HTML code, extensible markup language (XML) code, cascading style sheets (CSS) code, or code in any other language suitable for creating and displaying network content. Further, website data 216 may include code that generates dynamic network pages when executed or interpreted in the computing environment 103. Such code may be written in any suitable programming language, such as PHP, Perl, Objective C, Java, Ruby, etc. Website data 216 may also include code configured to be executed or interpreted within the client device 106 in order to render a dynamic network content. Such code may be referred to as applets and may be written in any suitable programming language, such as JavaScript, Java, etc. Website data 216 may also include authentication information that allows a user to login and create and edit the website 200. Authentication data may include username and passwords, either stored in plaintext, encrypted or hashed form. Authentication data can also include other type of data used to authenticate a user or a client device, such as biometric information, single sign-on data, etc.

In various embodiments, website data 216 may include HTML code that represents a shell of the website. For example, pre-generated HTML code may be used as the basis for creating each of the pages of the website. The pre-generated HTML code may have queries, such as JavaScript queries, that retrieve content from the data store 116 to include customized data for the website. For example, the pre-generated HTML code may include JavaScript code to retrieve a website header that is stored as one website attribute 203a. The pre-generated HTML code may also include JavaScript code that retrieves a background image from template store 119.

The template store 119 can store a number of templates, such as template 230a, 230b, and 230c. Each template can include a corresponding template category. Examples of template categories can be professionals, doctors, home service providers, etc. The doctor template category can be associate with business attributes such as primary care provider, dentist, etc. Additionally, each template 230 may include corresponding template data 234. Template data 234a may include images, videos, audio files, audiovisual files, fonts, HTML files, stylesheets, links to one or more of images, videos, audio files, audiovisual files, fonts, HTML files, stylesheets, and/or code, etc., that correspond to the corresponding template 230. Additionally, in some embodiments, template data 234 can include other data that is used to create a website when the corresponding template is used. This may include, for example, CSS code that can be used to create various aspects, such as a common stylesheet to use to define a theme of the website. In various embodiments, each template in the template store 119 has its own pre-generated HTML code that is used as a basis for creating a website from that template. In various embodiments, the images, videos, audio files, audiovisual files, fonts, etc., may be stored in a filesystem and linked to the template store 119.

The template store 119 also stores template mappings 239. Template mapping 239 stores a mapping of template categories 233 to business attributes 206. Each template category 233, e.g. 233a and 233b, stored in template mapping 239 may include one or more corresponding business attributes 206, e.g. 206a, 206b, or 206c. In the example of FIG. 2, template category 233a corresponds to business attributes 206a and 206b, and template category 233b corresponds to business attribute 206c. Template mapping 239 is used to select one or more templates 230 that match a user-provided business attribute. In various embodiments, template mapping 239 is queried to determine a template category, e.g. 233a that matches a user provided business attribute. For example, if builder interface 172 receives business attribute 206a from a user, querying template mapping 239 for a matching template category will yield template category 233a. Next, template store 119 is queried to determine which of templates 230 have a template category 233 that matches the desired template category 233a. In this case, this will yield template 230a.

Next, a general description of the operation of the various components of the networked environment 100 is provided. To begin, a user may use the client device 106 to access the builder service 123 over the network 113. Specifically, the user may direct the browsing application 169 to a specific URL or domain name associated with the builder service web server 129 of the computing environment 103. The builder service web server 129 may be, for example, a commercially available or publically available web server, such as, for example, an Apache web server. The builder service web server 129 hosts the builder service 123. The builder service 123 can require a user to be authenticated prior to allowing the user to proceed. The user management service 139 is used to authenticate the user. The user management service 139 can also be used to register new users. The user management service 139 can also include functionality for allowing users to make payments, sign up, add new services, or renew their services. Once the user is authenticated by the user management service 139, the client interface service 136 transmits code that is executable on the client device 106 and causes the browsing application 169 to render the builder interface 172 on the display 163.

In various embodiments, the builder interface 172 is a web application, such as a Java application, that is executed by the browsing application 169 and communicates with the builder service 123 via the network 113. In various other embodiments, the builder interface 172 is a standalone application, such as a windows executable, an iOS application, an Android application, etc. that is executed by the client device 106.

In various embodiments, the builder interface 172 can render HTML files and/or code as web pages, receive edits made to the webpages, and convert the edits back to HTML file and/or code. The builder interface 172 receives the HTML files and/or code from the website generator 133 and displays the HTML as a website. The user can interact with the builder interface 172 and make any edits to the displayed page, such as, for example, change text, rearrange visual elements, add elements such as text, images, links, videos, etc., delete existing elements, and/or any other type of edit as can be appreciated. The builder interface 172 can convert the changes being made by the user back to HTML code and can send the updated code back to the website generator 133. For example, the builder interface 172 may detect that a user added an image to a webpage. The builder interface 172 may then create HTML code that would render the image on the website. This HTML code would be added to the existing HTML code for the image in a memory of the client device 106 and can be sent to the website generator 133.

The builder interface 172 is used for accessing the website generator 133. The user may first provide a business name and a business attribute via the builder interface 172. The business attribute can be selected from a list of predefined business types. In various embodiments, the website generator 133 stores the user provided business attribute 206 in data store 116, corresponding to website 200. The user may also select pages and features to be included with the website. Examples of pages that the user may select include an ‘About Us’ page, a ‘Contact Us’ page, a page to setup online appointments, a page to provide directions to the physical location of the business, and/or any other type of page as can be appreciated. These choices can be saved by the website generator 133 in the data store 116. For example, the data store 116 can store the website attribute provided by the user as website attribute 203a. Further, the data store 116 may also store information about various pages to be included as website structure 209a.

In various embodiments, a user can select, via the builder interface 172, various functionalities that can be included in the website from a predefined list. For example, such functionality may include providing online scheduling of appointments, hosting a blog, receiving online payments, such as via PayPal, credit card payments, etc. The various embodiments, the functionality may include a subscription or member only area, where members of the website 200a can access certain member only, or paid content.

Once the user has provided information about the type of website and the structure, the website generator 133 may then create a website for the user. The website generator 133 selects a template for the website. The template is selected based at least in part on the business attribute 206a provided by the user. The website generator 133 queries the template mapping 239 in template store 119 to determine one or more template categories that match with the user provided business attribute. As described above, business attribute 206a corresponds to template category 233a. Website generator 133 then uses template 230a to create website 200a. In various embodiments, each template category corresponds to a single business attribute, e.g. template category 233b shown in FIG. 2. In various other embodiments, each template category may correspond to multiple business attributes, e.g., template category 233a shown in FIG. 2.

Further, the website generator 133 can retrieve stored data from template data 234a. The stored data may include pre-generated HTML code and any related code, such as CSS, XML, etc. The pre-generated HTML code may be a shell that can be used to create a website that corresponds to the selected template. The pre-generated HTML code includes the images and other audiovisual aspects of the selected template. For example, the pre-generated HTML code for template 230a may include images that correspond to template 230a as links in the HTML code. Further, in some embodiments, the pre-generated HTML code can also include certain queries, such as, for example, JavaScript queries, that retrieve other content from the template store 119. In various embodiments, the pre-generated HTML code is selected based on the template selected by the user and the website structure selected by the user. For example, the user may select various pages to include in the website. Each of those structure options may correspond to pre-generated HTML code. For example, if the user selects to include a ‘Contact Us’ page in the website, corresponding pre-generated code for a contactus.html page may be retrieved and dynamically linked to the main website page, home.html.

In various embodiments, the pre-generated HTML code may be the same for some or all of the templates. However, in some embodiments, the pre-generated HTML code may contain sections which may include references to other files that may be specific to the selected template. For example, the pre-generated HTML code may contain links to specific style files, which include the formatting and other theme related information for website. These specific style files, such as CSS, may be specific to the selected theme. Each of the theme-specific CSS files may also contain references to images that are to be used for that particular theme. The pre-generated HTML code retrieved from template store 119 may then be stored as website data 216a.

The builder interface 172 may also allow various aspects of the created website to be edited by the user. Any edits made by the user are stored accordingly in data store 116. For example, the user may add content such as text, images, etc. to the website during editing. These changes can be saved as website content 213a in the data store 116. Alternatively, some of the content can be saved as HTML code in website data 216a. Further, the builder interface 172 may also allow the user to add another page to the website or another section to an existing page of the website. This may be saved in website structure 209a in the data store 116. Further, when a page is added, for example, the website generator 133 may retrieve the pre-generated HTML code corresponding to the new page from the template store 119 and store it as website data 216a. Additionally, the user may decide to change business attribute 206a. This may cause the website generator 133 to use a different template, e.g. template 230b, that corresponds to the newly selected business attribute, e.g., 206c.

The builder interface 172 can also preview the website. According to various embodiments, a preview of the website can be rendered by the client device 106 via the builder interface 172. The website generator 133 can generate the preview of the website by creating HTML pages from website data 216a that combine various aspects of the website, such as template 230a that corresponds to business attribute 206a, website structure 208a, and website content 213a to create website data 216a. In various other embodiments, website data 216a can be previously generated, simultaneous to the design and editing of the website. HTML code stored in website data 216a is then transmitted to the builder interface 172 that displays the preview of the website.

The preview represents how the website will look when it is published to web server 109 and accessed via the World Wide Web by another user. The user previewing the website may click through various links for the various pages of the website to ensure the desired functionality and look and feel. The user may return to editing the website if they discover errors or wish to make further changes.

Prior to publishing a website, the website is not accessible directly via a web address selected by the user, such as a newly registered domain name or an existing domain name. The web address of the website may point to web server 109, which does not have any content of the website prior to it being published. Further, prior to be website being published, it may only be accessible via builder service 123 by a user that can be authenticated by user management service 139. In various embodiments, the HTML code and other files and/or code corresponding to the various webpages of the website are stored as website data 216a. The code may contain links or references to other information in data store 116 or template store 119.

In various embodiments, the builder interface 172 can allows the user to publish the website to web server 109. This process may be executed by the publisher service 126. In various embodiments, the publisher service 126 may generate a static version or a snapshot version of the website to upload to the web server 109. The publisher service 126 can retrieve any HTML code and other code and/or files stored in data store 116 as website data 216a. The publisher service 126 can scan the retrieved code to determine any dependencies, such as image files, JavaScript queries, external links, etc. to determine if these dependencies need to be resolved. For example, a dependency may include a reference to a background image that is stored in template store 119. Another example of a dependency may include a JavaScript file/code that retrieves a list of subpages from website structure 209a for the website and displays it as a menu bar. Another example could be JavaScript code that retrieves a business address of the business operating the website from website content 213a in data store 116 and displays the location on a map. Since some or all of these dependencies retrieve certain information from data store 116 and/or template store 119, the publisher service 126 can replace the dependency with a static reference to the information. In the above examples, the publisher service 126 may retrieve the background image and store the image file alongside a HTML file containing the HTML code and replace the link in the HTML code to point to the retrieved image file. The publisher service 126 may replace the JavaScript code with actual links to the subpages. The publisher service 126 may also store the business address of the business in the HTML file that displays the map instead of having the business address retrieved from data store 116. The publisher service 126 then generates various HTML files and/or other files from the HTML code and/or other code. The generated files are then uploaded to web server 109 such that web server 109 can serve the website to any requestor. The files may be uploaded via FTP or any other suitable file transfer protocol.

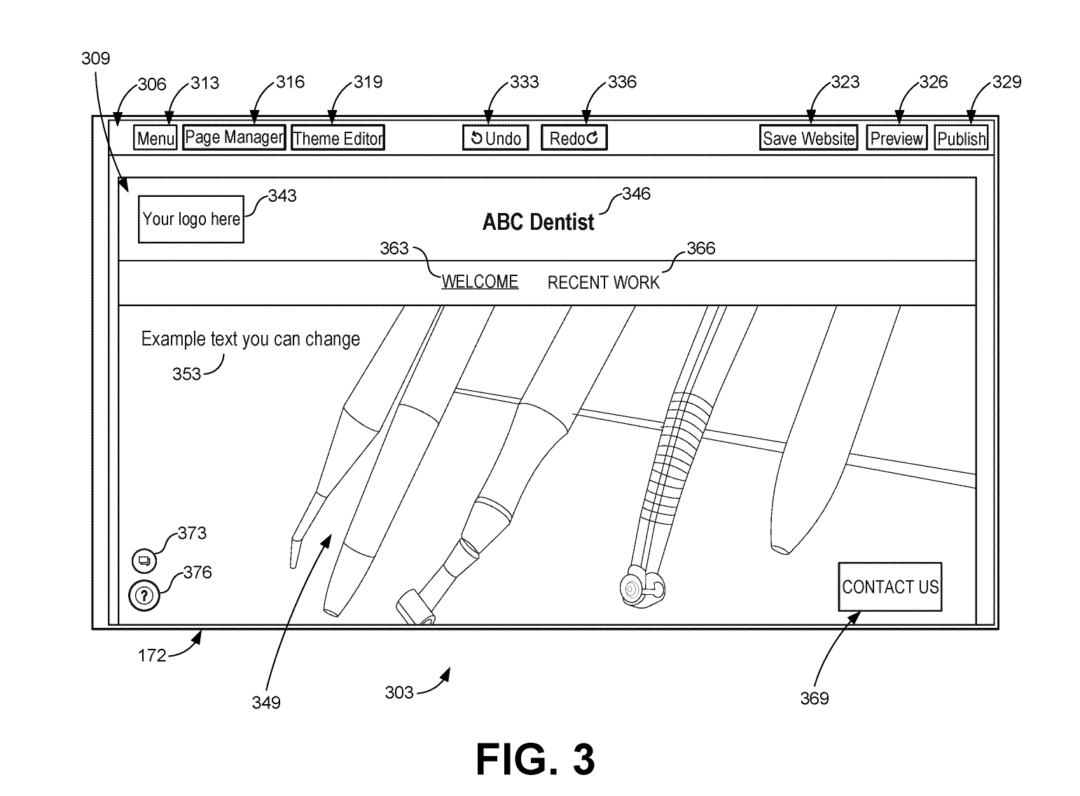

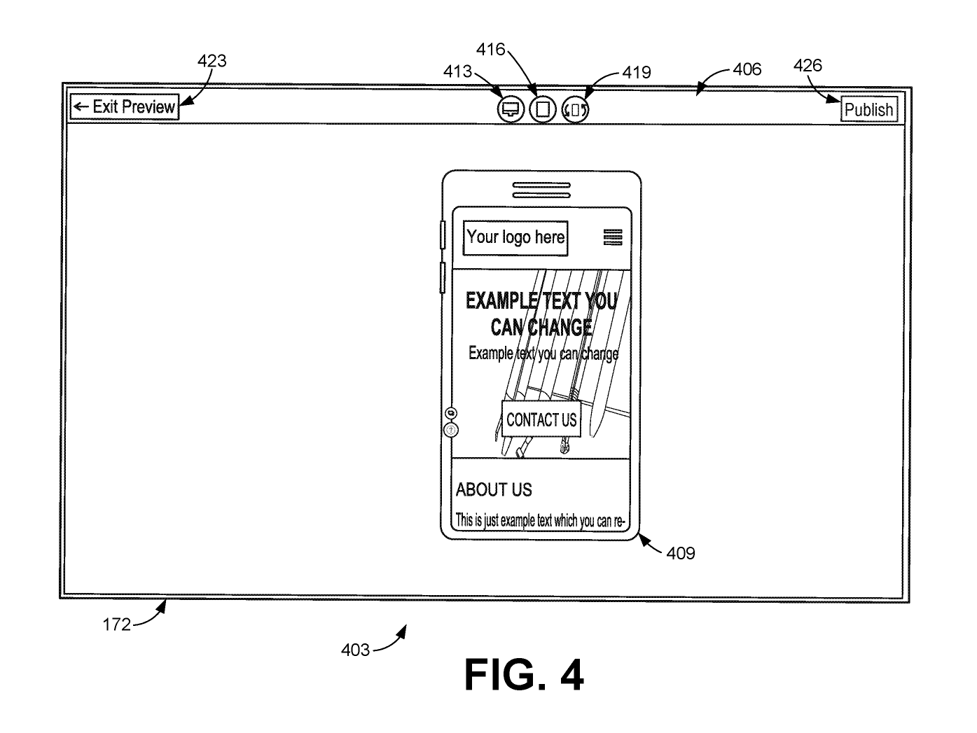

Turning now to FIGS. 3-4, shown are pictorial diagrams of example user interfaces rendered by a client device in the networked environment of FIG. 2 according to various embodiments of the present disclosure. FIG. 3 depicts an example edit interface 303 that shows the builder interface 172 rendered on the display 163 of the client device 106. The edit interface 303 allows a user to first provide inputs relating to website attributes 203a, business attribute 206a, and website structure 209a. Based on these inputs, website generator 133 creates a website 200a. As discussed, website 200a can be created by using pre-generated HTML code stored in the template store 119. The pre-generated HTML code may be modified by the website generator 133 and stored as website data 216a. Website data 216a is then sent to the builder interface 172 that renders the HTML code to display the edit interface 303 and enables the user to edit the website. The edit interface 303 renders a command bar 306 and an edit window 309. The command bar 306 may contain various buttons that correspond to various actions relating to the website displayed in the edit window 309. For example, the command bar 306 may include a menu button 313, a page manager button 316, a theme editor button 319, a save website button 323, a preview button 326, a publish button 329, an undo button 333, and a redo button 336.

The menu button 313 may invoke a menu by the edit interface 303. The menu may include various options, such as to add pages, change website details, etc. The page manager button 316 may invoke an interface to add webpages, edit webpages, or delete webpages that are included with the website. The theme editor button 319 may invoke an interface that allows the user to change the theme of the website. In various embodiments, the user may change the theme by selecting a different business attribute 203a associated with website 200a. By selecting a new business attribute 203a, the website generator 133 may retrieve a template that has a template category 233 that matches the newly selected business attribute 203a. In various embodiments, the edit interface 303 may display or cycle through various templates available in the template store 119 until the user selects one to use. The templates displayed by the edit interface 303 may be filtered based on a new business attribute 203a provided by the user, or a template category selected by the user.

The save website button 323 can save any unsaved changes made by the user to the data store 116. The preview button 326 can cause the edit interface 303 to display the website in preview mode, as described in more detail herein. The publish button 329 can cause the publisher service 126 to publish the website to the web server 109 as described in more detail herein. The undo button 333 and the redo button 336 cause an action to either be undone or repeated.

The edit window 309 may display the layout of the website or individual pages of the website. The edit window 309 may display the website such that it may be edited visually. Various elements of the website may be shown that can be edited or removed. For example, the edit window 309 may display various aspects of the website that can be edited, such as a logo 343, a website header 346, a background image 349, and text 353. Some of these aspects may be generated based on the user's inputs corresponding to the website attributes 203a and the business attribute 206a. For example, the background image 349 may be from the selected template 230a. Further, the shape and color of various elements may also be defined in the template 230a and retrieved from the template store 119. Additionally, the website header 346 may correspond to one or more of the website attributes 203a.

The edit window 309 may also display other editable aspects of the website, such as links to various other pages of the website, for example, a home page link 363, a recent work link 366, a contact us link 369, a chat link 373, and a help link 376. These various links may be tied to various actions related to the website. During edit mode, these actions may not be executable. For example, the chat link 373 may not actually open up a chat window, or redirect to a page with a chat window.

Turning to FIG. 4, shown is an example preview interface 403 that shows the builder interface 172 rendered on the display 163 of the client device 106, according to various embodiments of the present disclosure. The preview interface 403 may be displayed when a user invokes the preview mode by selecting the preview button 326 of the edit interface 303 (shown in FIG. 3). The website generator 133 generates a preview version of the website and transmits the generated preview version to the client device 106 to be rendered by the preview interface 403. The preview interface 403 may include options to preview the website in various modes, such as desktop mode, tablet mode and mobile mode. Mode buttons 413 and 416 may be used to switch between various modes. When the user selects one of these buttons, the preview of the website is changed to match the selected mode. Further, the displayed mode buttons may be changed depending on the current mode. For example, the preview interface 403 depicted in FIG. 4, shows that the user has selected a mobile preview mode. Hence, the mode buttons 413 and 416 correspond to a desktop mode and a tablet mode. Mobile mode is not one of the options available in this mode, since the current mode is mobile mode. However, a rotate display button 419 is displayed to emulate the rotation of the mobile device, so that the preview can be switched between portrait and landscape modes. The preview of the website is displayed inside a mobile window 409 which emulates the look of a mobile phone. Further, the mobile window 409 also emulates the website displayed in the browser of a mobile phone of a user. In various embodiments, the preview mode is generated by the publisher service 126 in a manner similar to publishing the website, except instead of transmitting the generated files to web server 109, the generated files are transmitted to client device 106 to be rendered by builder interface 172.

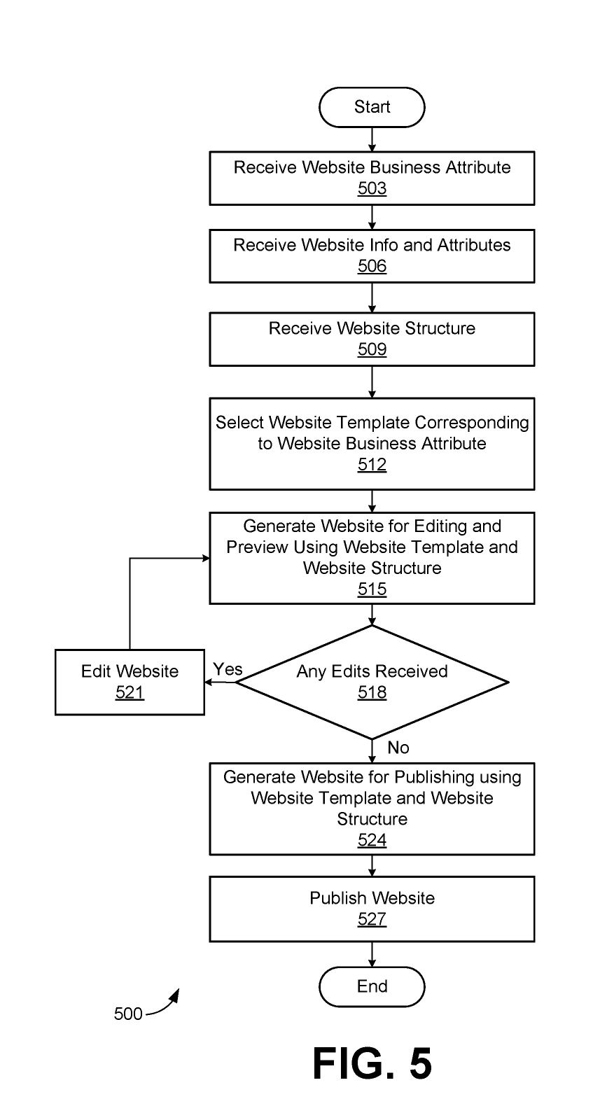

Referring next to FIG. 5, shown is a flowchart that provides one example of the operation of a portion of the builder service 123 (FIG. 1) according to various embodiments. It is understood that the flowchart of FIG. 5 provides merely an example of the many different types of functional arrangements that may be employed to implement the operation of the portion of builder service 123 as described herein. Beginning with reference numeral 503, the website generator 133 of the builder service 123 receives a business attribute 206a from a user creating the website 200a. In various embodiments, the business attribute 206a is selected from a list of business attributes. This list of business attributes may be stored in the data store 116 or in the template store 119. In various embodiments, the list of business attributes may be extracted from the template store 119 by querying template mapping 239 for unique values of the business attributes 206 stored therein. At reference number 506, the website generator 133 receives website information and attributes such as website attributes 203a. The website generator 133 may store these in the data store 116.

At reference number 509, the website generator 133 receives user input regarding various pages, elements, components, functionality, and/or plugins to be included in website 200a and stores this information as website structure 209a. For example, the user may select various pages from a predetermined list that are to be included. The website structure 209a may be stored in the data store 116. At reference number 512, the website generator 133 selects a template to use to create the website. The template is selected on the basis of business attribute 206a provided by the user. In various embodiments, the website generator 133 may query the template store 119 to retrieve one or more templates that have a template category 233 that matches the user selected business attribute 206a. If there are more than one template matches, in various embodiments, the builder interface 172 may display the matching templates and allow the user to select one of the matching templates. In various other embodiments, the website generator 133 may select one template from the matching templates.

At reference number 515, the website generator 133 generates the website. The website generator 133 retrieves the template data 234 for the selected template from the template store 119. The website generator 133 also uses certain pre-generated HTML code that may be stored in the data store 116 to create one or more pages for the website. The HTML code for the generated pages may then be stored in the data store 116 as the website data 216 or may be stored in one or more memory. The website generator 133 sends the generated HTML code for the website to the builder interface 172 where the HTML code is then rendered by builder interface 172 that allows editing the website. At reference number 518, the builder interface receives any edits and/or updates made by the user to the website. Any updates made by the user are converted to updates to the underlying HTML code by the builder interface 172 and sent back to the website generator 133 which stores the modified HTML code in the data store 116 at reference number 521.

If there are no further edits to be made, the user may decide to publish the website. At reference number 524, the website generator 133 may receive the user input indicating that the website is to be published. At reference number 527, the website generator 133 invokes the publisher service 126 to publish the website to the web server 109.

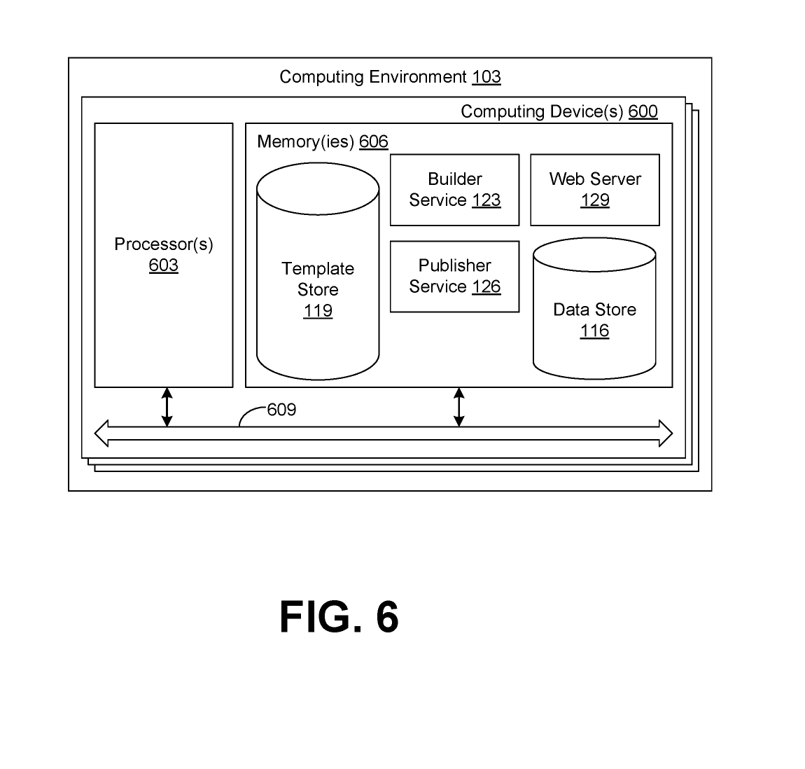

With reference to FIG. 6, shown is a schematic block diagram of the computing environment 103 according to an embodiment of the present disclosure. The computing environment 103 includes one or more computing devices 600. Each computing device 600 includes at least one processor circuit, for example, having a processor 603 and a memory 606, both of which are coupled to a local interface 609. To this end, each computing device 600 may comprise, for example, at least one server computer or like device. The local interface 609 may comprise, for example, a data bus with an accompanying address/control bus or other bus structure as can be appreciated.

Stored in the memory 606 are both data and several components that are executable by the processor 603. In particular, stored in the memory 606 and executable by the processor 603 are builder service 123, publisher service 126, and builder service web server 129. Also stored in the memory 606 may be a data store such as data store 116 and template store 119 and other data. In addition, an operating system may be stored in the memory 606 and executable by the processor 603.

It is understood that there may be other applications that are stored in the memory 606 and are executable by the processor 603 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 606 and are executable by the processor 603. In this respect, the term “executable” means a program file that is in a form that can ultimately be run by the processor 603. Examples of executable programs may be, for example, a compiled program that can be translated into machine code in a format that can be loaded into a random access portion of the memory 606 and run by the processor 603, source code that may be expressed in proper format such as object code that is capable of being loaded into a random access portion of the memory 606 and executed by the processor 603, or source code that may be interpreted by another executable program to generate instructions in a random access portion of the memory 606 to be executed by the processor 603, etc. An executable program may be stored in any portion or component of the memory 606 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 606 is defined herein as including both volatile and nonvolatile memory and data storage components. Volatile components are those that do not retain data values upon loss of power. Nonvolatile components are those that retain data upon a loss of power. Thus, the memory 606 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 603 may represent multiple processors 603 and/or multiple processor cores and the memory 606 may represent multiple memories 606 that operate in parallel processing circuits, respectively. In such a case, the local interface 609 may be an appropriate network that facilitates communication between any two of the multiple processors 603, between any processor 603 and any of the memories 606, or between any two of the memories 606, etc. The local interface 609 may comprise additional systems designed to coordinate this communication, including, for example, performing load balancing. The processor 603 may be of electrical or of some other available construction.

Although the builder service 123, the publisher service 126, the builder service web server 129, the website generator 133, the client interface service 136, the user management service 139, the data store 116, the template store 119, the browsing application 169, the builder interface 172, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowchart of FIG. 5 shows the functionality and operation of an implementation of portions of the builder service 123, the publisher service 126, the builder service web server 129, the website generator 133, the client interface service 136, the user management service 139, the data store 116, the template store 119, the browsing application 169, and the builder interface 172. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 603 in a computer system or other system. The machine code may be converted from the source code, etc. If embodied in hardware, each block may represent a circuit or a number of interconnected circuits to implement the specified logical function(s).

Although the flowchart of FIG. 5 shows a specific order of execution, it is understood that the order of execution may differ from that which is depicted. For example, the order of execution of two or more blocks may be scrambled relative to the order shown. Also, two or more blocks shown in succession in FIG. 5 may be executed concurrently or with partial concurrence. Further, in some embodiments, one or more of the blocks shown in FIG. 5 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that comprises software or code, including the builder service 123, the publisher service 126, the builder service web server 129, the website generator 133, the client interface service 136, the user management service 139, the data store 116, the template store 119, the browsing application 169, or the builder interface 172, can be embodied in any non-transitory computer-readable medium for use by or in connection with an instruction execution system such as, for example, a processor 603 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the builder service 123, the publisher service 126, the builder service web server 129, the website generator 133, the client interface service 136, the user management service 139, the data store 116, the template store 119, the browsing application 169, and the builder interface 172, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 600, or in multiple computing devices 600 in the same computing environment 103.

Among embodiments, some aspects of the present invention are implemented by a computer program executed by one or more processors, as described and illustrated. As would be apparent to one having ordinary skill in the art, the present invention may be implemented, at least in part, by computer-readable instructions in various forms, and the present invention is not intended to be limiting to a particular set or sequence of instructions executed by the processor.

The embodiments described herein are not limited in application to the details set forth in the following description or illustrated in the drawings. The invention is capable of other embodiments and of being practiced or carried out in various ways. Also, the phraseology and terminology used herein is for the purpose of description and should not be regarded as limiting. The use of “including,” “comprising,” or “having” and variations thereof herein is meant to encompass the items listed thereafter, additional items, and equivalents thereof. The terms “connected” and “coupled” are used broadly and encompass both direct and indirect connections and couplings. In addition, the terms “connected” and “coupled” are not limited to electrical, physical, or mechanical connections or couplings. As used herein the terms “machine,” “computer,” “server,” and “work station” are not limited to a device with a single processor, but may encompass multiple devices (e.g., computers) linked in a system, devices with multiple processors, special purpose devices, devices with various peripherals and input and output devices, software acting as a computer or server, and combinations of the above.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Embodiments of the present disclosure may be defined, for example, by the following clauses.

Clause 1. A system for creating a website, comprising: a template store comprising a plurality of templates, each of the plurality of templates corresponding to at least one template category, and each template category corresponding to at least one business attribute; a data store comprising website data; and a computing device having memory with instructions stored, wherein when executed by the computing device, the instructions cause the computing device to: transmit code to a client computing device, the code causing a display device connected to the client computing device to display a user interface associated with a builder application; receive a plurality of inputs, via the user interface, corresponding to a plurality of attributes related to a website and a plurality of structure aspects related to the website, wherein at least one of the plurality of attributes includes a business attribute; retrieve, from the template store, at least one template from the at least one template category that corresponds to the business attribute received via the user interface; generate a first version of the website, wherein the first version of the website comprises code that contains references to at least one of: the at least one template retrieved from the template store, the plurality of attributes, or the plurality of structure aspects; transmit the code of the first version of the website to the builder application, wherein the builder application causes the first version to be displayed via a second user interface by the display device connected to the client computing device, the second user interface allowing a user using the builder application to modify the website and preview the website; and generate code corresponding to a second version of the website by parsing the code of the first version of the website to remove the references.

Clause 2. The system of clause 1, wherein the computing device is further configured to store the code of the first version of the website in the data store.

Clause 3. The system of clause 2, wherein the computing device is further configured to update the stored code of the first version of the website in the data store.

Clause 4. The system of clause 1, wherein the computing device is further configured to transfer the code corresponding to the second version of the website to a web server.

Clause 5. The system of clause 1, wherein the code corresponding to the first version of the website can render a first mode of the website and a second mode of the website, the first mode corresponding to a first device type and the second mode corresponding to a second device type.

Clause 6. A system, comprising: a data store; a template store comprising a plurality of templates, each of the plurality of templates corresponding to at least one business attribute; and a computing device having memory with instructions stored, which when executed by the computing device cause the computing device to, at least: receive, via a user interface associated with a builder application, a business attribute related to a website and a plurality of structure aspects related to the website; retrieve, from the template store, at least one template that corresponds to the business attribute received from the user interface; generate a first version of the website using, at least in part, the at least one template retrieved from the template store and the plurality of structure aspects; transmit data encoding the first version of the website to the builder application, wherein the builder application causes the first version to be displayed via the user interface; and generate a second version of the website, based at least in part on the first version.

Clause 7. The system of clause 6, wherein the computing device is further configured to receive a plurality of attributes related to a website and wherein the plurality of attributes include at least one of: a business name, a website address, or the business attribute.

Clause 8. The system of clause 7, wherein the computing device is further configured to generate the first version of the website by storing, in the data store, at least the plurality of attributes, the plurality of structure aspects, references to the at least one template, and content information related to the website.

Clause 9. The system of clause 8, wherein the computing device is further configured to modify the website via the builder application by updating at least one of the plurality of attributes, the plurality of structure aspects, the references to the at least one template, or the content information stored in the data store.

Clause 10. The system of clause 8, wherein the computing device is further configured to generate the first version of the website by generating HTML code that comprises references to at least one of the plurality of attributes, the plurality of structure aspects, the template, or the content information related to the website.

Clause 11. The system of clause 10, wherein the computing device is further configured to generate the second version of the website by parsing the HTML code generated for the first version of the website to remove the references to at least one of the plurality of attributes, the plurality of structure aspects, the template, or the content information related to the website.

Clause 12. The system of clause 11, wherein the references to at least one of the plurality of attributes, the plurality of structure aspects, the template, or the content information related to the website are replaced with at least one of: a result yielded by resolving the reference, or a direct link to a file that can be exported.

Clause 13. The system of clause 11, wherein the computing device is further configured to transmit HTML code corresponding to the second version of the website to a web server, wherein the web server is configured to receive a request to access the website from a second client computing device, and wherein the web server transmits HTML code corresponding to the second version of the website to the second computing device.

Clause 14. A method for creating a website, comprising: receiving, by a computing device, a plurality of attributes and a plurality of structure aspects related to the website, the plurality of attributes and the plurality of structure aspects being received via a client application executed on a client device, and at least one of the plurality of attributes including a business attribute; retrieving, by the computing device, at least one template that corresponds to the business attribute from a template store; generating, by the computing device, data encoding a first version of the website based at least in part on the at least one template, the plurality of attributes and the plurality of structure aspects; transmitting, by the computing device, the data encoding the first version of the website to the client application, the data causing the client application to display the first version of the website via a client user interface; receiving, by the computing device, at least one edit to the website via at least one input on the client user interface; modifying, by the computing device, at least one of the plurality of attributes or the plurality of structure aspects, in response to the at least one edit; generating, by the computing device, data encoding an edited first version of the website; and generating, by the computing device, a second version of the website, by creating a published version of the edited first version.

Clause 15. The method of clause 14, further comprising uploading, by the computing device, the second version of the website to a web server that can be accessed via a network.

Clause 16. The method of clause 14, further comprising editing, by the computing device, the structure aspects related to the website stored in a data store.

Clause 17. The method of clause 16, further comprising: updating, by the computing device, the data store with the edited structure aspects related to the website; and recreating, by the computing device, the second version of the website based at least in part on the edited structure aspects.

Clause 18. The method of clause 14, further comprising receiving, via the computing device, data encoding at least one edit to the first version of the website from the client application, wherein input corresponding to the at least one edit is received by the client user interface, and the data encoding the at least one edit is generated by the client application.

Clause 19. The method of clause 14, further comprising generating a client optimized version of the website based at least in part on a client device type.

Clause 20. The method of clause 14, further comprising: receiving, by the computing device, a second business attribute; retrieving, by the computing device, at least one second template that corresponds to the second business attribute from the template store; and regenerating, by the computing device, data encoding the first version of the website based at least in part on the at least one second template, the plurality of attributes and the plurality of structure aspects.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1. A system for creating a website, comprising:
a template store comprising a plurality of templates and a plurality of template mappings, each of the plurality of templates corresponding to at least one template category, and individual ones of the plurality of template mappings comprise a mapping for the at least one template category to at least one business attribute;
a data store comprising website data; and
a computing device having memory with instructions stored, wherein when executed by the computing device, the instructions cause the computing device to:
transmit code to a client computing device, the code causing a display device connected to the client computing device to display a user interface associated with a builder application;
receive a plurality of inputs, via the user interface, corresponding to a plurality of attributes related to a website and a plurality of structure aspects related to the website, wherein at least one of the plurality of attributes includes a business attribute;
determine the at least one template category for the website based at least in part on the business attribute received via the user interface, the at least one template category being mapped to the business attribute;
select, from the template store, at least one template from the at least one template category based at least in part on the at least one template being mapped to the at least one template category;
generate a first version of the website, wherein the first version of the website comprises code that contains references to at least one of: the at least one template retrieved from the template store, the plurality of attributes, or the plurality of structure aspects;
transmit the code of the first version of the website to the builder application, wherein the builder application causes the first version to be displayed via a second user interface by the display device connected to the client computing device, the second user interface allowing a user using the builder application to modify the website and preview the website; and
generate code corresponding to a second version of the website by parsing the code of the first version of the website to remove the references.

2. The system of claim 1, wherein the computing device is further configured to store the code of the first version of the website in the data store.

3. The system of claim 2, wherein the computing device is further configured to update the stored code of the first version of the website in the data store.

4. The system of claim 1, wherein the computing device is further configured to transfer the code corresponding to the second version of the website to a web server.

5. The system of claim 1, wherein the code corresponding to the first version of the website can render a first mode of the website and a second mode of the website, the first mode corresponding to a portrait mode of a mobile device and the second mode corresponding to a landscape mode of the mobile device.

6. A system, comprising:
a data store;
a template store comprising a plurality of templates, each of the plurality of templates corresponding to at least one business attribute; and
a computing device having memory with instructions stored, which when executed by the computing device cause the computing device to, at least:
receive, via a user interface associated with a builder application, a business attribute related to a website and a plurality of structure aspects related to the website;
determine at least one template category for the website based at least in part on the business attribute received via the user interface, the at least one template category being mapped to the business attribute;
retrieve, from the template store, at least one template associated with the at least one template category;
generate a first version of the website using, at least in part, the at least one template retrieved from the template store and the plurality of structure aspects;
transmit data encoding the first version of the website to the builder application, wherein the builder application causes the first version to be displayed via the user interface; and
generate a second version of the website, based at least in part on the first version.

7. The system of claim 6, wherein the computing device is further configured to receive the plurality of attributes related to the website and wherein the plurality of attributes include at least one of: a business name, a website address, or the business attribute.

8. The system of claim 7, wherein the computing device is further configured to generate the first version of the website by storing, in the data store, at least the plurality of attributes, the plurality of structure aspects, references to the at least one template, and content information related to the website.

9. The system of claim 8, wherein the computing device is further configured to modify the website via the builder application by updating at least one of the plurality of attributes, the plurality of structure aspects, the references to the at least one template, or the content information stored in the data store.

10. The system of claim 8, wherein the computing device is further configured to generate the first version of the website by generating HTML code that comprises references to at least one of the plurality of attributes, the plurality of structure aspects, the at least one template, or the content information related to the website.

11. The system of claim 10, wherein the computing device is further configured to generate the second version of the website by parsing the HTML code generated for the first version of the website to remove the references to the at least one of the plurality of attributes, the plurality of structure aspects, the at least one template, or the content information related to the website.

12. The system of claim 11, wherein the references to the at least one of the plurality of attributes, the plurality of structure aspects, the at least one template, or the content information related to the website are replaced with at least one of: a result yielded by resolving the reference, or a direct link to a file that can be exported.

13. The system of claim 11, wherein the computing device is further configured to transmit HTML code corresponding to the second version of the website to a web server, wherein the web server is configured to receive a request to access the website from a second client computing device, and wherein the web server transmits HTML code corresponding to the second version of the website to the second client computing device.

14. A method for creating a website, comprising:
receiving, by a computing device, a plurality of attributes and a plurality of structure aspects related to the website, the plurality of attributes and the plurality of structure aspects being received via a client application executed on a client device, and at least one of the plurality of attributes including a business attribute;
determining, by the computing device, at least one template category for the website based at least in part on the business attribute, the at least one template category being mapped to the business attribute in a template store;
retrieving, by the computing device, at least one template associated with the at least one template category from the template store;
generating, by the computing device, data encoding a first version of the website based at least in part on the at least one template, the plurality of attributes and the plurality of structure aspects;
transmitting, by the computing device, the data encoding the first version of the website to the client application, the data causing the client application to display the first version of the website via a client user interface;
receiving, by the computing device, at least one edit to the website via at least one input on the client user interface;
modifying, by the computing device, at least one of the plurality of attributes or the plurality of structure aspects, in response to the at least one edit;
generating, by the computing device, data encoding an edited first version of the website; and
generating, by the computing device, a second version of the website, by creating a published version of the edited first version.

15. The method of claim 14, further comprising uploading, by the computing device, the second version of the website to a web server that can be accessed via a network.

16. The method of claim 14, further comprising editing, by the computing device, the structure aspects related to the website stored in a data store.

17. The method of claim 16, further comprising:
updating, by the computing device, the data store with the edited structure aspects related to the website; and
recreating, by the computing device, the second version of the website based at least in part on the edited structure aspects.

18. The method of claim 14, further comprising receiving, via the computing device, data encoding at least one edit to the first version of the website from the client application, wherein input corresponding to the at least one edit is received by the client user interface, and the data encoding the at least one edit is generated by the client application.

19. The method of claim 14, further comprising generating a client optimized version of the website based at least in part on a client device type.

20. The method of claim 14, further comprising:
receiving, by the computing device, a second business attribute;
retrieving, by the computing device, at least one second template that corresponds to the second business attribute from the template store; and
regenerating, by the computing device, data encoding the first version of the website based at least in part on the at least one second template, the plurality of attributes and the plurality of structure aspects.
